(19) United States
(12) Patent Application Publication
(10) Pub. No.: US 2003/0014553 A1
(43) Pub. Date: Jan. 16, 2003

(54) General purpose host simulator

(76) Inventor: Rui Zhao, Paderborn (DE)

Correspondence Address: HARNESS, DICKEY & PIERCE, P.L.C., P.O. BOX 828, BLOOMFIELD HILLS, MI, 48303, US

(21) Appl. No.: 09/892,693

(22) Filed: Jun. 27, 2001

(51) Int. Cl. G06F 9/46

(52) U.S. Cl. 709/313; 709/318

(57) ABSTRACT

The present invention provides a simulation system for evaluating an application. The simulation system includes a description file for describing a host protocol specification defining an environment in which the application is operated. The description file contains a project object corresponding to the host protocol specification. The project object describes a message structure that is compatible with the host protocol specification. A host simulator is coupled to the description file. The host simulator is adaptable in response to accessing the project object, to communicate a message with the application that is compatible with the host protocol specification.

### BACKGROUND OF THE INVENTION

1. Field of the Invention

The present invention relates generally to host-simulators, and in particular to generic host-simulators for ATM application development.

2. Discussion of the Related Art

The use of a host-simulator during the development and testing of Automatic Teller Machine (ATM) applications has become an important design tool for testing the application control flow. A host simulator is used to simulate the host environment, including the hardware platform, in which an application is designed to operate. There are numerous potential ATM host environments and hardware platforms, with each host environment having uniquely defined communication protocols. Therefore, to ensure that the ATM application is compatible with as many of the host environments as possible, it is desirable to test the interaction of the ATM application with all of the potential host environments. Typically, to test the compatibility of an application, ATM application programmers will use either a specific version of the communication components or dummy host protocol components. Generally, during quality assurance (QA) testing, specific host simulators are developed to simulate each of the host environments. Designing a specific host simulator for each host environment requires extensive programming and debugging time. In addition, normally when changes are made to the application, each of the specific host simulators must also be changed.

While the conventional techniques of designing specific host simulators for each hardware platform can be used to provide a simulation environment for ATM applications, it has not proven capable of providing a flexible, reconfigurable simulation environment for testing the interaction between an ATM application and potential operating environments.

### SUMMARY OF THE INVENTION

The present host-simulator system and method provides a system for simulating the interaction between an ATM application and the host environment. The simulation system includes a description file for describing a host protocol specification defining an environment in which the application is operated. The description file contains a project object corresponding to the host protocol specification. The project object describes a message structure that is compatible with the host protocol specification. A host simulator is coupled to the description file. The host simulator is adaptable in response to accessing the project object, to communicate a message with the application that is compatible with the host protocol specification.

For a more complete understanding of the invention, its objects and advantages, reference may be had to the following specification and to the accompanying drawings.

### BRIEF DESCRIPTION OF THE DRAWINGS

FIG. 1 illustrates a simulation system in accordance with the teachings of the invention;

FIG. 2 illustrates a project object in accordance with the teachings of the invention; and

FIG. 3 illustrates a graphical user interface in accordance with the teachings of the invention.

### DETAILED DESCRIPTION OF THE PREFERRED EMBODIMENT

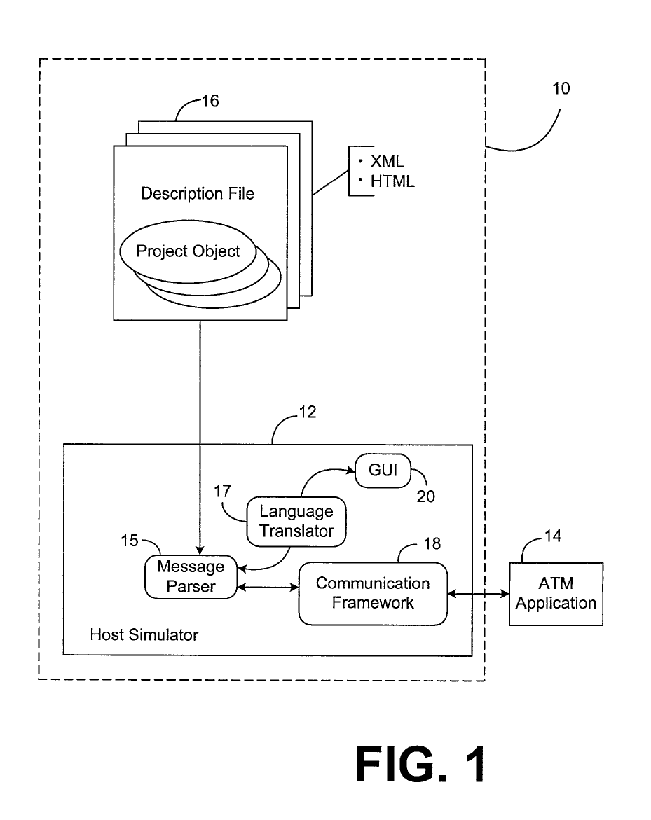

Referring to FIG. 1, a presently preferred embodiment of a simulation system 10 coupled to an ATM application 14 is shown. The simulation system 10 includes a general-purpose host simulator 12 for simulating the environment in which the ATM application 14 will execute. The simulation system may also be configured to simulate the ATM application 14. The general-purpose host simulator 12 is not limited to a specific host protocol definition, instead the general-purpose host simulator 12 may be operated with multiple selectable host protocol definitions. Coupled to the host simulator 12 is a description file 16 that enables the general-purpose host simulator 12 to be selectably reconfigured to simulate a host employing a specific host protocol specification. The description file 16 provides the flexibility to adapt to different underlying host protocols on the fly. The description file 16 preferably uses the eXtensible Markup Language (XML) for message definition and description to describe the structure of a message within a specific host protocol. Although, the description file 16 is preferably written in XML, it is within the scope of the invention to use any hierarchical markup language.

By using the description file 16, a user is able to “customize” the simulation system 10 to support several preselected protocols without recompiling the simulator 12 or writing new code. The “customizing” is relatively easy and intuitive: The user preferably creates one or more description files 16 describing the structure of the messages. After receiving information from the description file 16 about the structure of the protocol, the host simulator 12 is able to “understand” the protocol.

The description of a protocol message structure uses a simple string based language. The host simulator 12 includes a message parser 15 to parse messages and assign a value to each of the message fields. To support parsing, each host message field has a name assigned within the description of the message. The message parser 15 uses a packed version of the information in the description file 16 for parsing messages. In the packed version, the markup tree is flattened and preferably all markup information is removed to facilitate parsing of the messages. Parsing the messages into message fields enables the separate fields of the message to be analyzed and the use of a powerful graphical user interface, GUI, 20 to provide a display of the actual messages. A user oriented view of the messages is provided in which the XML tree structure is used for displaying the message as a two dimensional graphical output. Thus, a dual representation technique is used for the data described by the markup language. First a packed version is used for parsing messages. Second, a user oriented version is used for displaying output. Further details of the message structure are provided in a subsequent section of this specification.

A language translator 17, for use with simulation environments that do not directly support XML, is preferably coupled between the message parser 15 and GUI 20. The language translator 17 translates from XML to HTML.

An important feature of many host simulators is the capability to test the communication component of the application. This means that the more widely used communication protocols are preferably supported. Therefore, the host simulator 12 preferably includes a communication framework 18 for supporting numerous communication protocols, including TCP/IP, Named Pipes, and X.25. The presently preferred embodiment of the host simulator 12 uses a ProTopas communication framework to establish a connection between the ATM application 14 and the simulation system 10 since ProTopas includes software components for the supported communication protocols.

The programming language Java is chosen for implementing the host simulator 12. Java has powerful graphical user interface components including Swing, which makes the implementation of the graphical user interface 20 simple and reliable. In addition, Java is platform independent, so the simulation system 10 can be ported to different computer platforms. The Java Native Interface is used as an interface between ProTopas and the Java components so that the ProTopas communication framework is accessible to the host simulator 12.

A host message protocol is described using six elements; a project definition, a group format definition, a message format definition, a message definition, an event definition, and a command-sequence definition.

The message format is similar to a class, giving only formatting information. Whereas, a message is something like an object, or a concrete host message with defined field values. Group format is used to reduce the description effort by collecting commonly used message fields. For example, date and time can be grouped together since they are used in almost every host message. Events and commands specify the simulation conditions that control the simulation actions.

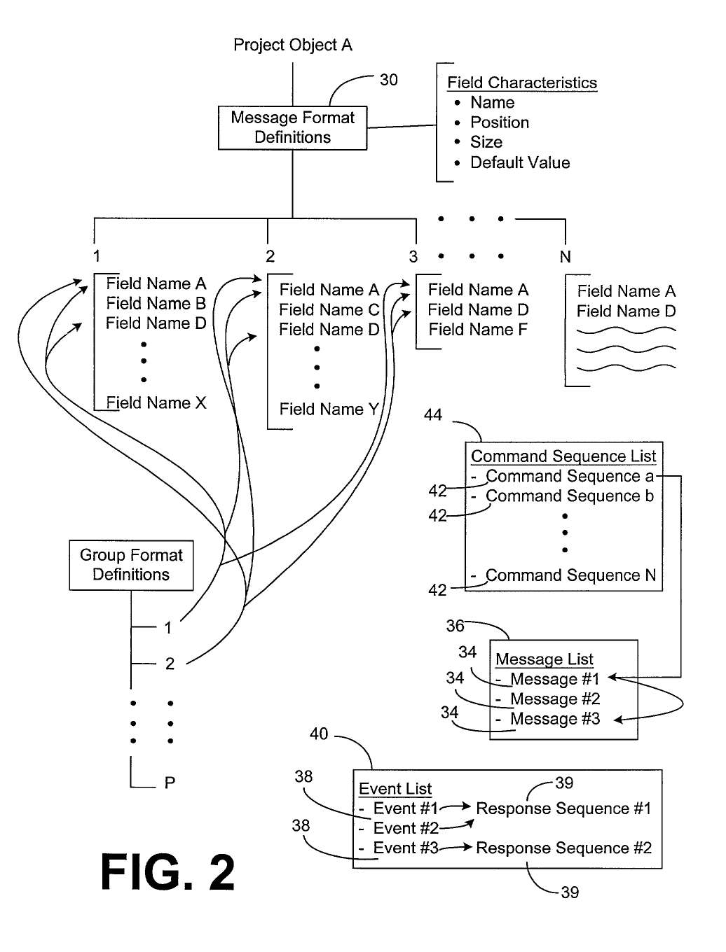

Referring to FIG. 2, a presently preferred embodiment of a project object in accordance with the teachings of the invention is illustrated. The project class is the top-level description element encompassing the other definitions associated with a host message protocol. The tags within a project object provide general project information such as the simulation environment. When a simulation is started, the host simulator 12 includes a reference to a project object that corresponds to a simulation environment. The corresponding project object comprises the definitions associated with the simulation environment. Preferably, a project object is created or opened before a simulation is run. Typically, a project object includes one or more group format definitions 32 and message format definitions 30. Preferably, the entire project object is stored in a single description file constructed using a hierarchical markup language such as XML.

The group format 32 defines which message fields can be stored in a group. Each message format 30 contains several fields. Each field has a name, a size and a default value. When receiving or sending a message, the fields are assigned predetermined values. The message fields are organized into groups. A group is a container for fields. This enables advanced features and makes the message formats much more compact.

A message format (or message type) 30 is a description of the structure of a message. The message format 30 describes the message field characteristics such as name, position, default value, and size. The graphical user interface components use the message format information during the simulation for presentation of the host data such as displaying the field characteristics in a table.

A message format 30 uses references to groups 32. Generally, a field is not defined directly within a message format 30. It is defined within a group 32. The referenced groups 32 may be set “optional”. This means the existence of a group 32 depends on the values of some fields in the message. This is especially useful for complex host protocols.

A message is a defined string which is associated with a specific message format. The message may be constructed from a mixture of fields having different group formats and field formats. Thus, the same fields may be used to define inputs such as trigger events and outputs such as messages. In addition, the value of a field may be used to select one of several messages. The field values within the message are preferably assigned by specifying a value for the field corresponding to a field name.

A message name is associated with each message. The host simulator can send a message by referencing the corresponding message name. Messages that can be sent are listed in a project object message list 36 with any associated message names. When defining the reaction to an event or when assembling a command sequence 42 the user may select a message 34 from the message list 36, create a new message, or select a command sequence 42 from a command sequence list 44.

An event 38 defines how the host simulator 12 reacts when there is an incoming message. For each event 38 there are one or more conditions. If all conditions are fulfilled, a response sequence 39 is executed. The response sequence 39 may consist of actions such as commands to send a message, display a Dialog-Box on screen, and request that a user assemble a message at run-time.

A command sequence 42 may be executed by the user (e.g. click on a button). These command sequences 42 are very similar to the response-sequence 39 of an event 38. They may contain several commands to send messages etc.

To further explain the XML host message description, a simple artificial host message protocol and its corresponding XML definition are presented as an example. Assume we have a host message with only one message format. That means the messages sent from the ATM application to the simulation host have the same format as messages sent from the simulation host to the ATM application. Table I represents a typical specification style. The message code field represents different messages, e.g. AA for Authorization request, PN for process next.

TABLE I

| Field name | Pos. | Size | Default Value |
|---|---|---|---|
| Message Code | 0 | 2 | xx |
| ATM Number | 2 | 4 | 1234 |
| Operation Code | 6 | 2 | 99 |
| Date | 8 | 6 | YYMMDD |
| Time | 14 | 6 | HHMMSS |

The code listing in Table II represents the XML definition corresponding to the host message protocol presented in Table I.

[image]

With the above few lines the host simulator 12 can be used, for example, to send a message from the host simulator by using the graphical user interface and filling the field values interactively. However, add some pre-defined messages 34 in a message list 36 or define events 38 in an event list 40 for automatic responses, and the power of the host simulator becomes evident.

To include pre-defined messages and an automatic response, add the lines from Table III before </ChameleonHostSim>.

[image]

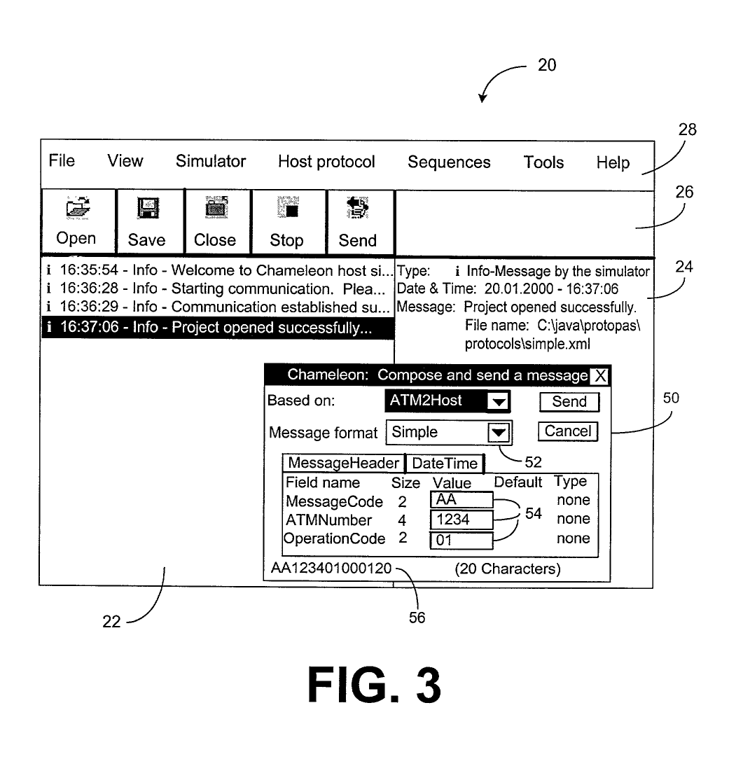

Referring to FIG. 3, a presently preferred embodiment of the GUI 20 is illustrated. The main window of the GUI 20 is divided into two main areas, a log-view window 22 and a message window 24. The log-view window 22 lists all incoming and outgoing messages, and info-messages seen by the host simulator 12. When a message in the log-view window 22 is selected, the corresponding detail information is displayed in the message window 24. A pop-up form 50 provides a convenient means of composing a message to be sent. The form 50 includes a combo box 52 for selecting a message format. Field entry boxes 54 facilitate entry of field values corresponding to the defined field names. Displayed at the bottom of the pop-up form 50 is a flattened version of the resulting message 56, in which the description language formatting and control characters have been removed. The resulting message 56 that is sent, preferably comprises only the values of the fields associated with the composed message.

The GUI 20 also includes a toolbar 26 and menu 28. The toolbar contains shortcuts to items that appear in the menu structure. The menu structure is presented in Table IV.

TAVLE IV
Menu Structure

| | |
|---|---|
| File: | Create, Open, Save, Close a project; Change |
| | the general project settings, |
| View: | What should appear in the area on the right |
| | (e.g. should the time be displayed or not etc.); |
| | change the look & feel; etc. |
| Simulator: | Start and stop communication; send |
| | messages; select the communication channel |
| | for using the communication |
| | framework. |
| Host protocol: | TCP/IP, Named Pipes, X.25 |
| Sequences: | User defined |
| Tools: | |
| Help: | |

Using the communication framework 18, different communication channels can be used. The host simulator can be used to simulate the ATM application 14 as well as a host. Preferably, the default configuration is set-up for simulating a host. For example, two instances of the host simulator can be created, one instantiation simulates a host, while the other instantiation simulates the ATM application. In this case the instantiation for the ATM application is preferably configured as the first communication channel and the Line parameter is set to “CLIENT”. (please explain)

### IN OPERATION

The start communication command uses the Java Native Interface to call the open command of the underlying ProTopas communication framework. In the message window 24, the result of the ProTopas communication framework functions is displayed.

As mentioned previously, a unique feature of the simulation system 10 is to use XML for creating the message description file 16. Therefore, an important command for the simulation is to load the message description file 16, and the project object corresponding to the host protocol that is to be simulated. This is done by executing the open project command. The name of the description file 16 is included as a parameter for the open project command.

The built-in XML parser 15 checks the description file 16 for possible errors. If an error is detected, the parser 15 provides the text line number within the description file 16 where the error occurred.

Next, the “Send” icon on the ATM side is selected. A message format is selected from the combo box 52, and the default field values are displayed. User selected values for the message fields are then input. The text area at the bottom of the GUI 20 displays the updated field values as the user inputs the values. After the changes to the field values have been entered, the message is ready to be sent. The user then selects send, and the simulator 12 sends the message as a string such as resulting message 56, using the ProTopas communication framework. In addition to composing a message to be sent, messages may be selected from the message list 36 or a command sequence 42 may be selected from the command sequence list 44.

When an incoming message string is received, the message parser 15 parses the incoming string and attempts to match the message to a defined message format 30 in the description file 16. Preferably, a list of possible messages corresponding to the received string are displayed on the GUI 20 for selection of the proper message format. XML formatting corresponding to the matching message format is appended to the string for enhancing the display. The possible messages are displayed in the user oriented view that includes the full tree structure of XML. The scope of the invention also includes automatically selecting the probable message format based on a set of previously defined heuristics such as comparing the types of characters that are expected in each of the message fields 54 to the received characters of the incoming message.

Thus it will be appreciated from the above that as a result of the present invention, a general purpose host simulator for simulating the interaction of an ATM application with a host environment is provided by which the principal objectives, among others, are completely fulfilled. It will be equally apparent and is contemplated that modification and/or changes may be made in the illustrated embodiment without departure from the invention. Accordingly, it is expressly intended that the foregoing description and accompanying drawings are illustrative of preferred embodiments only, not limiting, and that the true spirit and scope of the present invention will be determined by reference to the appended claims and their legal equivalent.

What is claimed is:

1. A simulation system for evaluating an application, comprising:
a description file for describing a host protocol specification defining an environment in which the application is operated, the description file containing a project object corresponding to the host protocol specification;
the project object describing a message structure that is compatible with the host protocol specification; and
a host simulator coupled to the description file, being adaptable in response to accessing the project object, for communicating a message with the application, the host simulator describing the message by a dual representation technique in which a first representation of the message provides a flattened version of the message, and a second representation of the message provides a hierarchical version of the message

2. The simulation system of claim 1 wherein the host simulator further includes a communication framework for supporting at least one communication protocol.

3. The simulation system of claim 2 wherein the at least one communication protocol is selected from the group of TCP/IP, Named Pipes, and X.25.

4. The simulation system of claim 1 wherein a hierarchical markup language is used in the description file for message definition and description.

5. The simulation system of claim 4 wherein the hierarchical markup language is XML.

6. The simulation system of claim 1 wherein the first representation of the message is used for data evaluation; and
wherein the second representation of the message is used for display.

7. The simulation system of claim 2 wherein the host simulator further includes a message parser for constructing and analyzing the message.

8. The simulation system of claim 2 wherein the project object includes a message format for describing message field characteristics associated with the message structure.

9. The simulation system of claim 8 wherein the message field characteristics are selected from the group of name, size, position, and default value.

10. The simulation system of claim 8 wherein the project object further includes a group format for storing selected message fields in a group.

11. The simulation system of claim 2 wherein the project object further includes a command sequence list.

12. The simulation system of claim 2 wherein the project object further includes a message list.

13. The simulation system of claim 2 wherein the host simulator further includes a message list and a command sequence list.

14. The simulation system of claim 2 wherein the host simulator further includes a message parser for parsing the message.

15. The simulation system of claim 2 wherein the host simulator further includes a language translator coupled between the message parser and GUI for translating XML to HTML.

16. A simulation system for evaluating an application, comprising:
a description file for describing a host protocol specification defining an environment in which the application is operated, the description file containing a project object corresponding to the host protocol specification;
the project object describing a message structure that is compatible with the host protocol specification;
a host simulator coupled to the description file, being adaptable in response to accessing the project object, for communicating messages with the application, the host simulator including a message parser for constructing and analyzing the messages, the message parser employing a dual representation technique of the messages such that a first representation of a message provides a packed version of the message, and a second representation of the message provides a user oriented view of the message for display; and
a communication framework for supporting at least one communication protocol.

17. The simulation system of claim 16 wherein the at least one communication protocol is selected from the group of TCP/IP, Named Pipes, and X.25.

18. The simulation system of claim 16 wherein the project object includes a message format for describing message field characteristics associated with the message structure.

19. The simulation system of claim 16 wherein the message structure is comprised of at least two fields having group formats and field formats, at least a one of the fields being usable to define both an event and a message output.

20. The simulation system of claim 16 further including a command sequence list having at least one command sequence.

21. The simulation system of claim 20 wherein the host simulator is activable, in response to receiving a predetermined input, to execute a predetermined command sequence.

22. The simulation system of claim 21 wherein the predetermined input is selected from the group of a predetermined message and a user request.

23. The simulation system of claim 21 wherein another simulator is adapted to simulate the application, such that the other simulator communicates with the host simulator; and
the other simulator is coupled to the description file for accessing the project object corresponding to the host protocol specification.

24. A simulation system for evaluating an application, comprising:
a description file for describing a host protocol specification defining an environment in which the application is operated, the description file containing a project object corresponding to the host protocol specification;
the project object describing a message structure that is compatible with the host protocol specification, the message structure being described by a message format and a group format, the project object including;
a message list including a plurality of selectable pre-constructed messages; and
a command sequence list including at least one command sequence defining a predetermined set of actions, the predetermined set of actions including sending a selectable pre-constructed message;
a host simulator coupled to the description file, being adaptable in response to accessing the project object, for communicating messages with the application, the messages complying with the message structure of the host protocol specification, the host simulator including a message parser for analyzing and constructing the messages, the message parser being operable to send a command sequence in response to receiving a predetermined message; and
a communication framework for supporting at least one communication protocol.
